(19) United States
(12) Patent Application Publication
(10) Pub. No.: US 2012/0093520 A1
(43) Pub. Date: Apr. 19, 2012

(54) MESH NODE FOR A COMMUNICATION MESH NETWORK STRUCTURE OF A NETWORKED CONTROL SYSTEM

(75) Inventors: Maurice Herman Johan Draaijer, Ittervoort (NL); Petrus Desiderius Victor Van Der Stok, Helmond (NL)

(73) Assignee: KONINKLIJKE PHILIPS ELECTRONICS N.V., EINDHOVEN (NL)

(21) Appl. No.: 13/259,399

(22) PCT Filed: Mar. 19, 2010
(86) PCT No.: PCT/IB2010/051195

§ 371 Date: Dec. 14, 2011

(30) Foreign Application Priority Data
Mar. 26, 2009 (EP) 09156259.5

(51) Int. Cl. H04B 10/00

(52) U.S. Cl. 398/165

(57) ABSTRACT

The invention relates to a mesh node for a communication mesh network structure of a networked control system, particularly a lean and mean infrared mesh node for a communication mesh network infrastructure of a lighting system such a green house lighting system. A basic idea of the invention is to implement a mesh node with a technical simple construction in the form of a base, on which optical transmitters are and optical receivers are arranged. An embodiment of the invention relates to a mesh node (10) for a communication mesh network structure of a networked control system comprising

a base (12),

optical transmitters (14) arranged on the base such that they can transmit data to optical receivers of other mesh nodes,

optical receivers (16) arranged on the base such that they can receive data from optical transmitters of other mesh nodes,

a processor (18) for interpreting data received via the optical receivers from other mesh nodes and routing data to other mesh nodes via the optical transmitters.

This construction allows implementing a communication mesh network structure for example for controlling a complex networked lighting system such as it may be applied in a green house, in which thousand of lamps are provided for creating a lighting atmosphere, which may controlled on a local basis.

### FIELD OF THE INVENTION

The invention relates to a mesh node for a communication mesh network structure of a networked control system, particularly an infrared mesh node for a communication mesh network infrastructure of a lighting system such as a green house lighting system.

### BACKGROUND OF THE INVENTION

Networked control systems are a ubiquitous trend in commercial, industrial and institutional business markets and also in consumer markets. An example of a networked control system is a networked lighting system with dozens of light sources. A very complex networked lighting system is a green house lighting system, which may comprises for example about 40000 lamps, which are placed in a grid kind of fashion and need to be managed in a flexible way. For example, lamps or clusters of lamps of such a lighting system should be individually controllable in order to create local light effects. Ideally, each lamp of such a lighting system can be individually controlled. However, this requires a complex installation such as a complex and costly cabling for controlling the lamps. W02004/075599A1 discloses a data transmission network comprising a mesh of nodes having optical transmitters and receivers. The transmission is preferably by modulated optical carriers, using laser diodes to transmit between nodes.

### SUMMARY OF THE INVENTION

It is an object of the invention to provide a mesh node for a communication mesh network structure of a networked control system, which may be implemented with a minimum of technical effort and is suitable for networked control system with up to thousands of nodes.

The object is solved by the subject matter of the independent claims. Further embodiments are shown by the dependent claims.

A basic idea of the invention is to implement a mesh node with a technical simple construction in the form of base with optical transmitters and optical receivers arranged on that base. According to an embodiment of the invention, the base may be a disk like shaped base, on which the optical transmitters may be arranged on one side of the disk-like shaped base, while on the other side of the disk-like shaped base optical receivers may be arranged. This construction allows implementing a communication mesh network structure for example for controlling a complex networked lighting system such as it may be applied in a green house, in which thousands of lamps are provided for creating assimilation light support, which may be controlled on a local basis with the communication mesh network structure.

An embodiment of the invention provides a mesh node for a communication mesh network structure of a networked control system comprising

a base,

optical transmitters arranged on the base such that they can transmit data to optical receivers of other mesh nodes,

optical receivers arranged on the base such that they can receive data from optical transmitters of other mesh nodes,

a processor for interpreting data received via the optical receivers from other mesh nodes and routing data to other mesh nodes via the optical transmitters.

The base may be a Printed Circuit Board (PCB) containing the wiring between the optical transmitters, optical receivers and the processor. Thus, the base serves not only as carrier for the optical receivers and transmitters and the processor, but also can provide a wiring for the electronic components of the mesh node.

Particularly, the optical transmitters and optical receivers may be adapted to transmit or receive data via infrared. Using the infrared spectrum for optical communication has the advantage that it is invisible and less interference-prone to visible light.

The sensitivity of the optical transmitters and optical receivers may be directional such that every transmitter and every receiver can communicate with one receiver or transmitter of another neighbored mesh node. A directional sensitivity has the advantage that an efficient optical communication in the network may be established with a minimum of distortion and interference. Also, the transmission medium does not need to be shared like in a radio approach between two mesh nodes.

The processor may be configured to route received data to other mesh nodes according to a predetermined routing scheme. For example, the processor may be configured to select the shortest routing path through the network.

Furthermore, the mesh node may comprise eight optical transmitters and eight optical receivers, wherein the optical transmitters are equally arranged at the boundary area of one side of the base and the optical receivers are arranged at the boundary area of the other side of the base such that every optical receiver matches with an optical transmitter on the opposite side of the base. This embodiment of the mesh node allows a communication also in diagonal directions in the communication mesh network structure of a networked control system.

Particularly, the optical transmitters and optical receivers may be implemented by means of infrared LEDs and infrared detectors designed for infrared remote control devices.

The mesh node may further comprise a control interface for a controllable lamp, and wherein the processor is configured to control a controllable lamp via the control interface depending on the interpreting of data received via the optical receivers from other mesh nodes.

The base of the mesh node may be shaped like a disk.

The optical transmitters may be arranged on one side of the disk-like shaped base and the optical receivers may be arranged on the other side of the disk-like shaped base.

A further embodiment of the invention relates to a greenhouse lighting system comprising several lamps being arranged in a grid, wherein each lamp comprises a mesh node according to the invention and as described above, and the mesh nodes are arranged such that they form a communication mesh network structure, in which control signals for the lamps can be routed through the mesh network structure via optical communication between the mesh nodes.

These and other aspects of the invention will be apparent from and elucidated with reference to the embodiments described hereinafter.

The invention will be described in more detail hereinafter with reference to exemplary embodiments. However, the invention is not limited to these exemplary embodiments.

### BRIEF DESCRIPTION OF THE DRAWINGS

FIGS. 1A and 1B show different views of an embodiment of the mesh node according to the invention;

FIG. 2 shows a perspective view of the embodiment of a mesh node as shown in FIGS. 1A and 1B;

FIG. 3 shows the optical communication between two mesh nodes in a communication mesh network structure according to the invention; and

FIG. 4 shows an example of a routing path through a communication mesh network structure with mesh nodes according to the invention.

### DETAILED DESCRIPTION OF EMBODIMENTS

In the following, functionally similar or identical elements may have the same reference numerals.

In the following, embodiments of the invention will be described by means of a lighting infrastructure for a greenhouse. Such lighting infrastructures, consisting of typical 40000 lamp units, placed in a grid kind of fashion, need to be managed in a flexible way. The mesh node according to the invention is lean and may be implemented at very low costs, which is an important factor for lighting infrastructures with thousand of lamp units and mesh nodes. Furthermore, a communication mesh network structure comprising the inventive mesh node comprises a lot of redundancy because the embodiment of the inventive mesh node as described in the following can communicate with eight other mesh nodes. This enables a very flexible routing of messages through the communication mesh network structure. Lamp units can be addressed and managed by means of the inventive mesh nodes because they all wirelessly communicate with each other. A main benefit of the embodiment of the inventive mesh node as described in the following is the directional effect of having eight narrow beam form shaped communication channels provided by the IR LEDs of the mesh nodes. The transmission medium does not need to be shared like in a radio approach between two nodes.

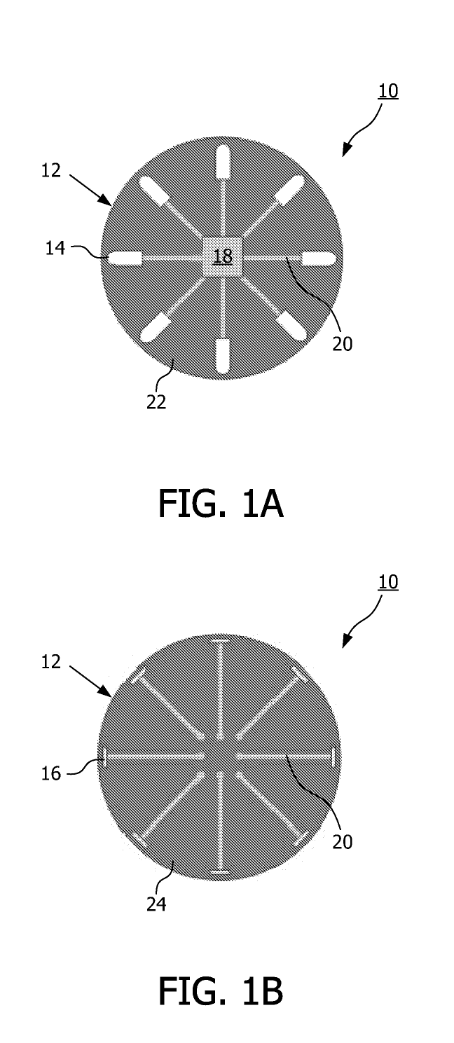

FIG. 1A shows a top view of an embodiment of the mesh node 10, which comprises a PCB 12. On the top side 22 of the mesh node 10, eight IR LEDs 14 are equally arranged at the border of the PCB 12. The eight IR LEDs 14 are equally distributed, i.e. substantially equispaced, at the border of the PCB 12. A microcontroller 18 is mounted in the middle of the PCB disc 12. The microcontroller 18 is connected with the IR LEDs 14 via a wiring 20 of the PCB 12. FIG. 1B shows the bottom side 24 of the mesh node 10. On this side 24, eight IR receivers 16 are also arranged at the border of the PCB 12. The IR receivers 16 are located directly under the IR LEDs 14. The bottom side 24 of the PCB 12 contains the wiring 20 between the IR receivers 16 and the microcontroller 18 on the top side 22. The IR LEDs and IR receivers can be devices, which are typically applied in IR remote controls for consumer electronics such as TV sets, DVD players. The microcontroller 18 both controls the IR LEDs and processes the signals from all eight IR receivers.

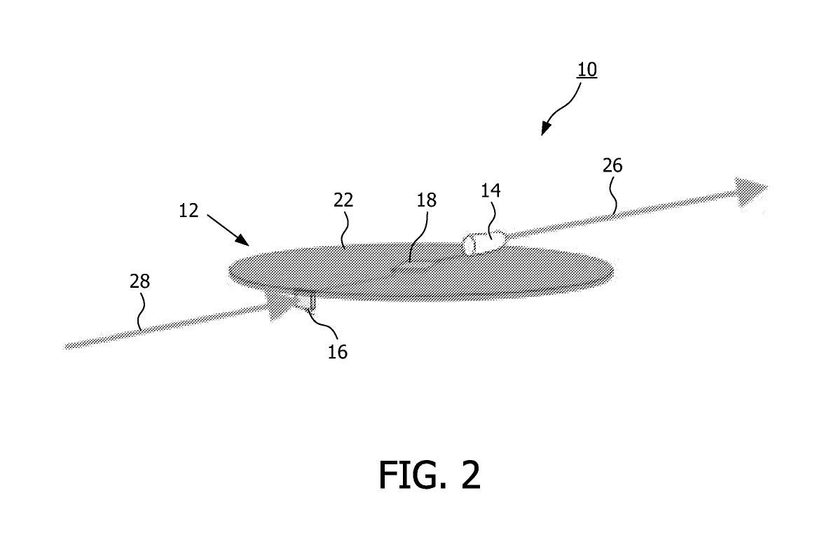

In a greenhouse, every lamp may be equipped with a mesh node 12 like that shown in FIGS. 1A and 1B. FIG. 2 shows a perspective view of the mesh node of FIGS. 1A and 1B and one of the 8 times 8 communication paths, which are possible in a communication mesh network structure consisting of these mesh nodes. An IR beam 28 arrives at the IR receiver 16. The microcontroller 18 interprets the data received with the IR beam and routes information to another node, based on a predetermined routing scheme, by means of an IR LED 14 and the IR beam 26.

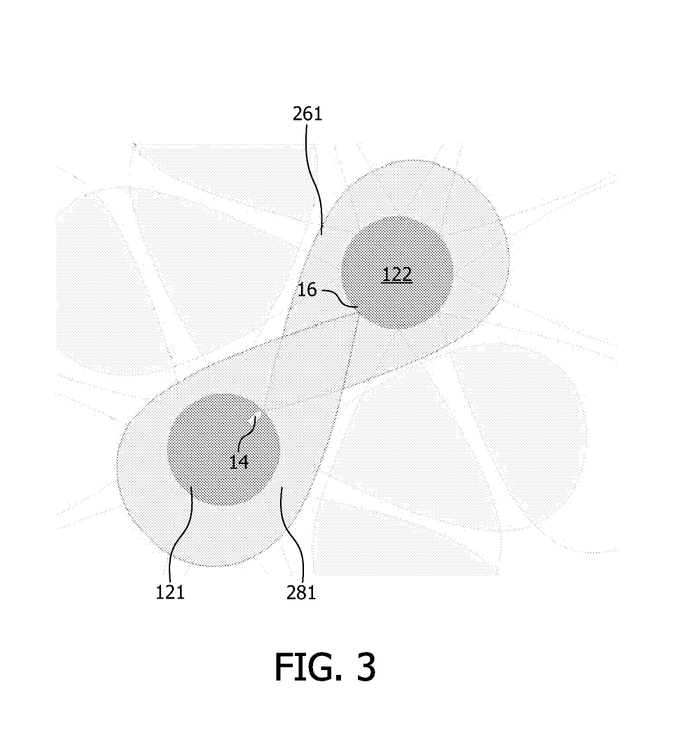

FIG. 3 shows a top view on a network of mesh nodes. The mesh nodes are arranged on the same layer in a grid like manner. Each mesh node has four direct neighbors, except the mesh nodes arranged at the border of the grid of mesh nodes. In FIG. 3, the radiation patterns 261 and 281 respectively for the IR LED 14 and the IR receiver 16 on the discs 121 and 122 of mesh nodes are shown. It can be seen that both radiation patterns 261 and 281 are directed to the respective mesh nodes. The reason for this directional approach is because reliable connections should be ensued if a mesh node has a line of sight to another mesh node. In FIG. 3 one connection is shown, but in practice the communication should not be restricted to single hops. A broadcast kind of communication (transmission and reception in all directions) and communicating simultaneously to multiple devices is of course possible.

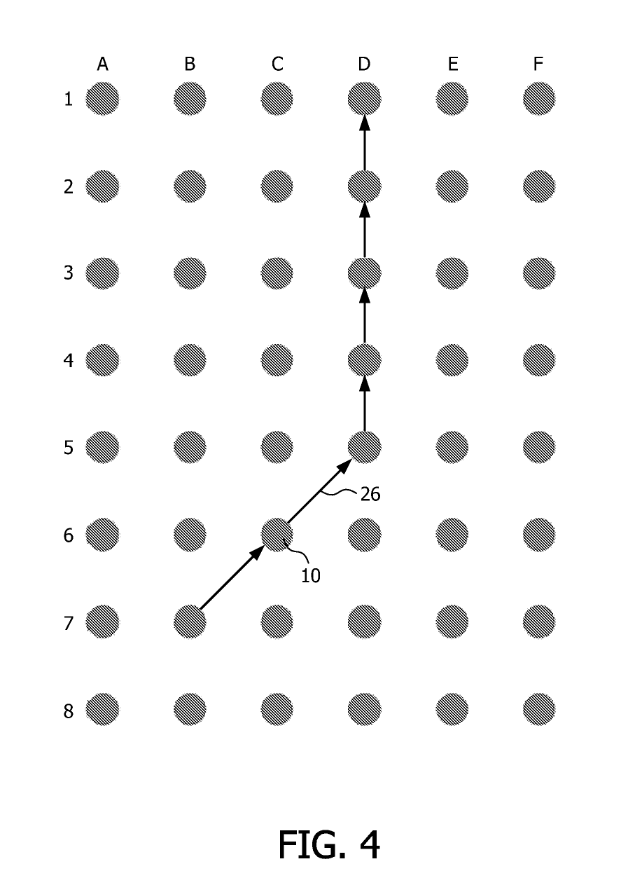

FIG. 4 shows a grid of inventive mesh nodes 10 and the routing of messages through this grid. The grid is a matrix with columns A . . . F and rows 1 . . . 8. Each mesh node may be addressed by its coordinates in the grid. In FIG. 4, the routing of a message transmitted from the mesh node at position B7 to the mesh node at position D1 is shown. The routing can be performed under certain constraints, for example to route a message via the shortest path as it is shown in FIG. 4. The mesh node of FIGS. 1 and 2 allows transmitting and receiving data in eight different directions in the grid, up, down, right, left and the four diagonal directions. In FIG. 4, the shortest path from mesh node at location B7 to mesh node at location D1 goes over the mesh node at location C6 via a diagonal communication direction, to the mesh node at location D5 also via a diagonal communication direction, and then over the mesh nodes at locations D4, D3, and D2 in the up communication direction. This example shows that the mesh node according to the invention enables an efficient routing of messages through a communication mesh network structure of a networked control system such as a green house lighting system with thousands of lamps, each being coupled to a mesh node according to the invention and being controllable by means of the mesh node. For controlling a lamp, each mesh node comprises a control interface, with which a control interface of a lamp may be coupled. Thus, the microcontroller of a mesh node may control a lamp connected to the control interface of the mesh node, if it receives control data for lamp from another mesh node, or from a central controller for the lighting system. A typical example is a local control of lamps in a large and complex greenhouse lighting system. For example, a central controller may transmit a message for dimming the lamps at locations E1, F1, E2 and F2 in the grid of mesh nodes and lamps of FIG. 4. The message may be first supplied by the central controller to the mesh node at location A8 and then routed from this mesh node to the mesh nodes at locations E1, F1, E2 and F2. The microcontrollers of these mesh nodes note upon receipt of the message that the lamp coupled to the respective mesh node should be dimmed to a certain value. Then, the microcontrollers shall send a control command via the control interface of the mesh node to the lamp coupled to the mesh node, which dims its light emission to the desired level.

The invention can be applied in any networked control system, particularly in a complex lighting system with a plurality of light sources, for example a lighting system installed in a green house. The invention is particularly applicable for creating a large communication mesh network structure with a small technical effort and at low costs.

At least some of the functionality of the invention may be performed by hard- or software. In case of an implementation in software, a single or multiple standard microprocessors or microcontrollers may be used to process a single or multiple algorithms implementing the invention.

It should be noted that the word “comprise” does not exclude other elements or steps, and that the word “a” or “an” does not exclude a plurality. Furthermore, any reference signs in the claims shall not be construed as limiting the scope of the invention.

1. A mesh node for a communication mesh network structure of a networked control system comprising
a base,
one or more optical transmitters arranged on the base for transmitting data to optical receivers of other mesh nodes,
optical receivers arranged on the base for receiving data from optical transmitters of other mesh nodes,
a processor for interpreting data received via the optical receivers from other mesh nodes and routing data to other mesh nodes via the optical transmitters.

2. The mesh node of claim 1, wherein the base is a Printed Circuit Board containing the wiring between the optical transmitters, optical receivers and the processor.

3. The mesh node of claim 1, wherein the optical transmitters and optical receivers are adapted to transmit or receive data via infrared.

4. The mesh node of claim 1, wherein the sensitivity of the optical transmitters and optical receivers is directional such that every transmitter and every receiver can communicate with one receiver or transmitter of another neighbored mesh node.

5. The mesh node of claim 1, where the processor is configured to route received data to other mesh nodes according to a predetermined routing scheme.

6. The mesh node of claim 1, comprising eight optical transmitters and eight optical receivers, wherein the optical transmitters are equally arranged at the boundary area of one side of the base and the optical receivers are arranged at the boundary area of the other side of the base such that every optical receiver matches with an optical transmitter on the opposite side of the base.

7. The mesh node of claim 1, wherein the optical transmitters and optical receivers are implemented by means of infrared LEDs and infrared detectors designed for infrared remote control devices.

8. The mesh node of claim 1, further comprising a control interface for a controllable lamp, and wherein the processor is configured to control a controllable lamp via the control interface depending on the interpreting of data received via the optical receivers from other mesh nodes.

9. The mesh node of claim 1 wherein the base is shaped like a disk.

10. The mesh node of claim 9, wherein the optical transmitters are arranged on one side of the disk-like shaped base and the optical receivers are arranged on the other side of the disk-like shaped base.

11. A greenhouse lighting system comprising several lamps being arranged in a grid, wherein each lamp comprises a mesh node according to the preceding claims, and the mesh nodes are arranged such that they form a communication mesh network structure, in which control signals for the lamps can be routed through the mesh network structure via optical communication between the mesh nodes.
